(19) United States
(12) Patent Application Publication
(10) Pub. No.: US 2011/0044855 A1
(43) Pub. Date: Feb. 24, 2011

(54) SYSTEMS AND METHODS FOR COLLECTION AND ANALYSIS OF ANALYTES

(75) Inventors: Douglas B. HENDERSON, Columbia, MD (US); Kenneth J. Ewing, Edgewater, MD (US); Danielle N. Dickinson, Odenton, MD (US)

Correspondence Address: TAROLLI, SUNDHEIM, COVELL & TUMMINO L.L.P., 1300 EAST NINTH STREET, SUITE 1700, CLEVELAND, OH, 44114, US

(73) Assignee: Northrop Grumman Systems Corporation

(21) Appl. No.: 12/917,749

(22) Filed: Nov. 2, 2010

Related U.S. Application Data
(62) Division of application No. 12/534,568, filed on Aug. 3, 2009.

(51) Int. Cl. G01N 30/00

(52) U.S. Cl. 422/68.1; 422/527

(57) ABSTRACT

Systems and methods are provided for collecting and analyzing analytes. One embodiment of the invention includes a system for collecting analyte. The system comprises a sampling section disposed on a collection platform and an air source that provides an analyte to be sorbed by the sampling section. The sampling section can be formed of a low pressure drop configuration of sorbent material

### TECHNICAL FIELD

The present invention relates generally to collection and analysis systems, and specifically to systems and methods for collection and analysis of analytes.

### BACKGROUND

The collection and analysis of vapor phase analytes is employed in many environments and applications. One technique for the collection and analysis of analytes is to utilize tubes (metal or glass) that are filled with a packed bed of bulk sorbent material to trap a range of vapor phase analytes. These sorbent tubes may exhibit relatively high pressure drops due to the packed bed height and therefore require a relatively strong pump to pull enough air through the packed bed to capture/trap a vapor phase analyte onto the sorbent material. To desorb the analyte trapped in the sorbent material for subsequent analysis, the tube needs be heated to a sufficient temperature for a sufficient amount of time. Due to the mass of the packed bed, high temperatures and longer desorption times are necessary to efficiently desorb the trapped analyte. For certain types of analytes, the high temperatures can cause degradation of some or all of the analyte resulting in inaccurate and inefficient analysis of the sample. Furthermore, it is often cumbersome and time consuming to obtain replicate analyses of the same sample since it requires switching of individual tubes after each sample and/or analysis. It is also difficult to obtain replicate analyses from a single sorbent tube. Decreasing size, power and sampling/analytical time are of particular interest to most mobile/field sampling applications.

### SUMMARY

In one aspect of the invention, a system for collecting analyte is provided. The system comprises a sampling section disposed on a collection platform and an air source that provides an analyte to be sorbed by the sampling section. In one configuration, the sampling section can be formed of a low pressure drop configuration of sorbent material.

In another aspect of the invention, a system is provided for collecting and analyzing analytes. The system comprises one or more sampling sections being formed of a low pressure drop configuration of sorbent material disposed about a collection platform. An air source provides an analyte to be sorbed by a given sampling section of at least one sampling section. A device drives the collection platform to align the given sampling section with the air source.

In yet another aspect of the invention, a method is provided for collecting and analyzing analytes. The method comprises providing a collection platform comprising a plurality of sampling sections with each of the plurality of sampling sections being formed of a low pressure drop configuration of sorbent material and repeatedly providing an analyte to be sorbed by a given sampling section of the plurality of sampling sections for each of the plurality of sampling sections.

### BRIEF DESCRIPTION OF THE DRAWINGS

FIG. 1 illustrates a system for collection and analysis of analytes in accordance with an aspect of the present invention.

FIG. 2 illustrates a rotatable collection disk during collection of analytes in accordance with an aspect of the present invention.

FIG. 3 illustrates the rotatable collection disk during analysis of analytes in accordance with an aspect of the present invention.

FIG. 4 illustrates an integrated system for collection and analysis of analytes in accordance with another aspect of the present invention.

FIG. 5 illustrates another system for collection and analysis of analytes in accordance with another aspect of the present invention.

FIG. 6 illustrates yet another system for collection and analysis of analytes in accordance with another aspect of the present invention.

FIG. 7 illustrates an example of a methodology for collecting and analyzing analytes in accordance with an aspect of the invention.

### DETAILED DESCRIPTION

The present invention relates to systems and methods for the collection and analysis of analytes. In one aspect of the invention, the systems and methods employ a platform containing one or more discrete, low pressure drop configuration of sorbent material. Air containing a given analyte is pumped or vacuumed through the one or more sampling sections during sampling. The low pressure drop configuration eliminates the pressure drop associated with pumping or vacuuming over a length of a tube. After sampling, the previously exposed sampling section is sealed. Once the single or multiple sections have been sampled, they can be removed from the collection system and inserted into an extraction system. Alternatively, the extraction system can be integrated with the collection system. The extraction system can utilize techniques such as solvent and thermal desorption or less destructive, more rapid techniques like ambient pressure desorption ionization or laser desorption to extract/desorb and/or ionize the sorbed analyte from each section. Multiple extractions can be removed from each individual section, for replicate samples analyses resulting in improved confidence. Moreover, the sections may be able to be reconditioned, allowing for subsequent sampling or may be disposable.

A sorbent section can be relatively thin (<5 mm) with a negligible pressure drop over a wide range of flow rates (e.g., up to 20 Liters per Minute (LPM)). Conventional sorbent tubes may exhibit low pressure drops at low flows (50 ml/min) but these pressure drops increase significantly with flow rate. Therefore, the current invention includes configurations of sorbent that can sample a larger volume of air in less time without requiring additional pumping power. With efficient transmission of the extractor flow, the desorption of analytes from the sampling section can also be more rapid than conventional sorbent tubes (e.g., <1 min vs>5 min).

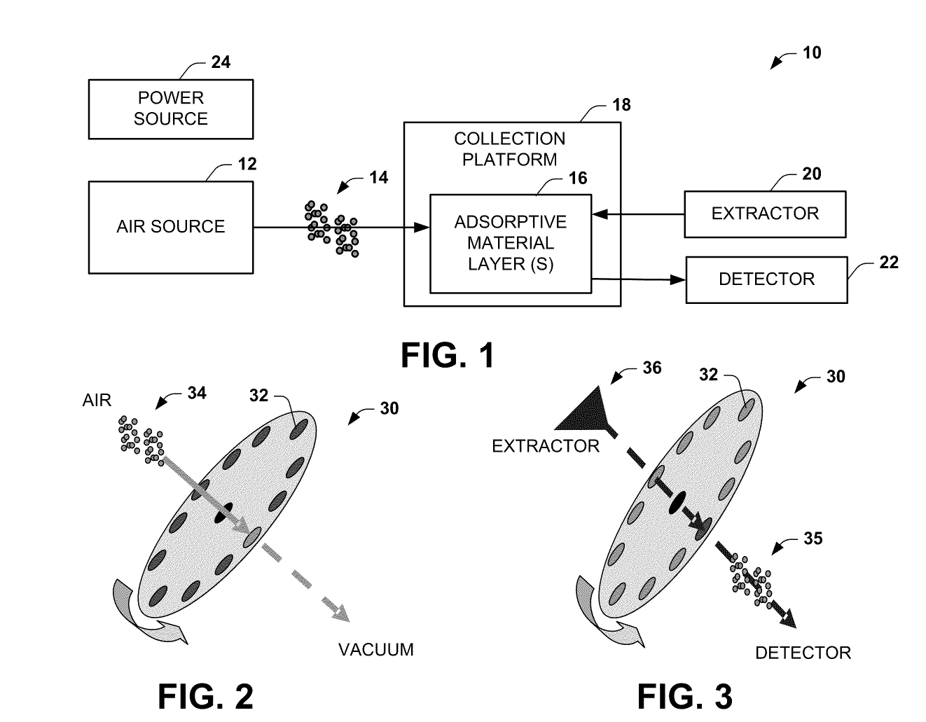

FIG. 1 illustrates a system 10 for collection and analysis of analytes in accordance with an aspect of the present invention. An air source 12 provides a supply of air containing a given analyte 14 through a low pressure drop configuration of sorptive material layer 16. Alternatively, the air source 12 can be a vacuum that pulls the analyte 14 through the sorptive material 16. The sorptive material 16 resides on a collection platform 18 such as a substrate that holds a section of the low pressure drop configuration of sorptive material layer 16. In one example of the invention, the collection platform 18 is a rotatable disk that includes a plurality of discrete sorbent material sampling sections. In another example of the invention, the collection platform 18 is a continuous roll (reel-to-reel) of sorbent material. The reel can be fed as sample is delivered to the sorbent material. In yet another example, the collection platform can be a roll of fiber, tape or string. In another example of the invention, a single sorbent section can be used. The collection platform can be designed to maximize exposure of the sorbent to the analyte 14, allow for isolation prior to and after sampling to eliminate sample-to-sample contamination, and minimize pressure drop.

An extractor 20 can extract the analyte 14 from the sorbent material 16 and provide the extracted analyte to a detector 22. The extractor 20 can be designed to rapidly extract/desorb analytes in a manner that minimizes sample degradation and efficiently delivers the analyte in a vapor phase to the detector 22. The extractor 20 can utilize techniques such as solvent and thermal desorption or less destructive techniques like ambient pressure desorption ionization or laser desorption to extract the sorbed analyte from the sorptive material 16. The extractor 20 and detector 22 can be a separate extraction system or integrated with a collector system that includes the air source 12. A power source 24 can provide power to at least one of the air source 12, the extractor 20 and the detector 22.

FIG. 2 illustrates a rotatable collection disk 30 during collection of analytes in accordance with an aspect of the present invention. The rotatable collection disk 30 includes a plurality of discrete sampling sections 32 disposed about a periphery of the rotatable collection disk 30. Each discrete sampling section 32 can be formed of a low pressure drop configuration of sorbent material. A given sample section is exposed to air via an air source or vacuum causing an analyte 34 to be sorbed by the sampling section 32. After sampling, the disk 32 rotates, sealing the exposed sampling section for later analysis and exposing a fresh sampling section for a subsequent air sample. This process can be repeated for each of the plurality of sampling sections 32. After each of the sampling sections 32 have been exposed to air, the rotatable collection disk 30 can be removed from the collection apparatus and provided to an analysis apparatus, or can enter an analysis stage if the collection and analysis functions are integrated into a single unit.

FIG. 3 illustrates the rotatable collection disk 30 during analysis of analytes in accordance with an aspect of the present invention. The disk 30 is loaded into an extractor system and a sorbed analyte on each individual sampling section 32 is extracted/desorbed for analysis using an extractor 36 that employs techniques such as solvent and thermal desorption or an ambient pressure desorption ionization. The extractor 36 can be, for example, an atmospheric pressure ionization source such as a Direct Analysis in Real Time (DART) source or a Desorption ElectroSpray Ionization (DESI) source. An extracted analyte 35 is then provided to a detector for analysis. After sampling, the disk 30 rotates providing another exposed sampling section 32 for extraction by the extractor 36 and detection by the detector for analysis of an extracted analyte. This process can be repeated for each of the plurality of sampling sections 32. Using this analysis configuration, it may be possible to conduct multiple extractions from each individual sample, thus allowing independent replicates for performing improved statistical analysis.

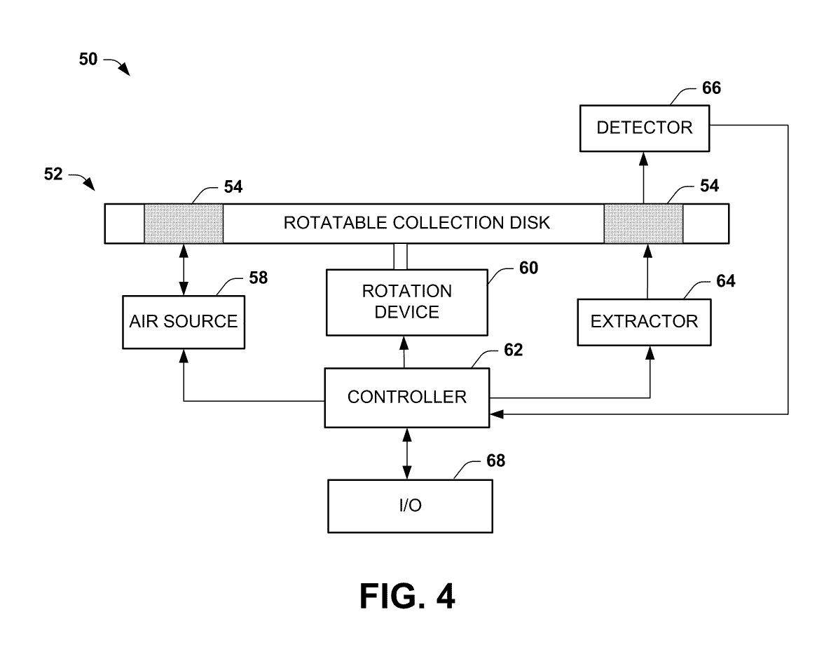

FIG. 4 illustrates an integrated system 50 for collection and analysis of analytes in accordance with another aspect of the present invention. A rotatable collection disk 52 is mounted on a shaft coupled to a rotation device 60. The rotation device 60 can be, for example, a stepper motor or other motor that can incrementally rotate the rotatable collection disk 52. The rotatable collection disk 52 includes a plurality of discrete sampling sections 54 disposed about a periphery of the rotatable collections disk 52. Each discrete sampling section 54 can be formed of a low pressure drop configuration of sorbent material. A given sample section 54 is exposed to air via an air source 58 that can be configured to pump air containing a given analyte or vacuum air to pull the analyte to be sorbed through the sampling section 54. An extractor 64 can extract the analyte from the sampling sections 54 and provide the extracted analyte to a detector 66. The extractor 64 can be designed to rapidly extract/desorb analytes in a manner that minimizes sample degradation and efficiently delivers the analyte to the detector 66. The extractor 64 can utilize techniques such as solvent and thermal desorption or less destructive techniques like ambient pressure desorption ionization or laser desorption to extract the sorbed analyte from each section 56.

A controller 62 is coupled to the air source 58, the sampling device 60, the extractor 64 and the detector 66. The controller 62 can be configured to turn the air source 58 on and off during a collection phase. For example, the controller 62 can be configured to turn on the air source 58 for a given sampling section 54, turn off the air source 58, drive the rotatable collection disk or reel or other platform holding the sampling section(s) 52 via the device 60 to align the next given sampling section 54 with the air source 58 and repeat the turning the air source 58 on and off during sampling and rotating the rotatable collection disk or reel or other platform holding the sampling section(s) 52 for each of the plurality of discrete sampling sections 54.

The controller 62 also controls the turning on and off of the extractor 64 for extracting analytes from the sampling sections 54. The extractor 64 can be an ambient pressure desorption ionization or laser desorption technique that causes the extraction/desorption of the analyte and providing of the analyte to the detector 66. The detector 66 be responsive to the analyte and provide signals to the controller 62. The controller 62 can determine the presence and/or type of analyte or the absence of an analyte and/or absence of a given type of analyte based on the signals provided by the detector 66. The controller 62 can be configured to turn on and off the extractor 64 for a given sampling section 54, send the signals from the detector 66 to the controller 62, analyze the signals, rotate the rotatable collection disk or reel or other platform holding the sampling section(s) 52 via the device 60 to align the next given sampling section 54 with the extractor 64 and repeat the turning the extractor 64 on and off during extraction and rotating the rotatable collection disk or reel or other platform holding the sampling section(s) 52 for each of the plurality of discrete sampling sections 54. Separate controllers for the air source 58, the sampling device 60, the extractor 64 and the detector 66 or integrated combinations of controllers may be included.

Input/output devices 68 are coupled to the controller 62 and can provide control signals for instructing the system 50 to begin collecting samples. The input/output devices 68 can also include a display for displaying results of the analysis of the collected samples by the controller 62. The controller 62 can be configured to receiving instruction for analysis of the collected samples. It is to be appreciated that the system 50 can also be configured to take a single sample and analyze a single sample as opposed to collecting a plurality of samples for each of the discrete sampling sections 54 prior to analysis. The controller 62 can also be configured to perform statistical analysis on the plurality of samples to determine the presence and/or type of analyte and provide results of the analysis to the display.

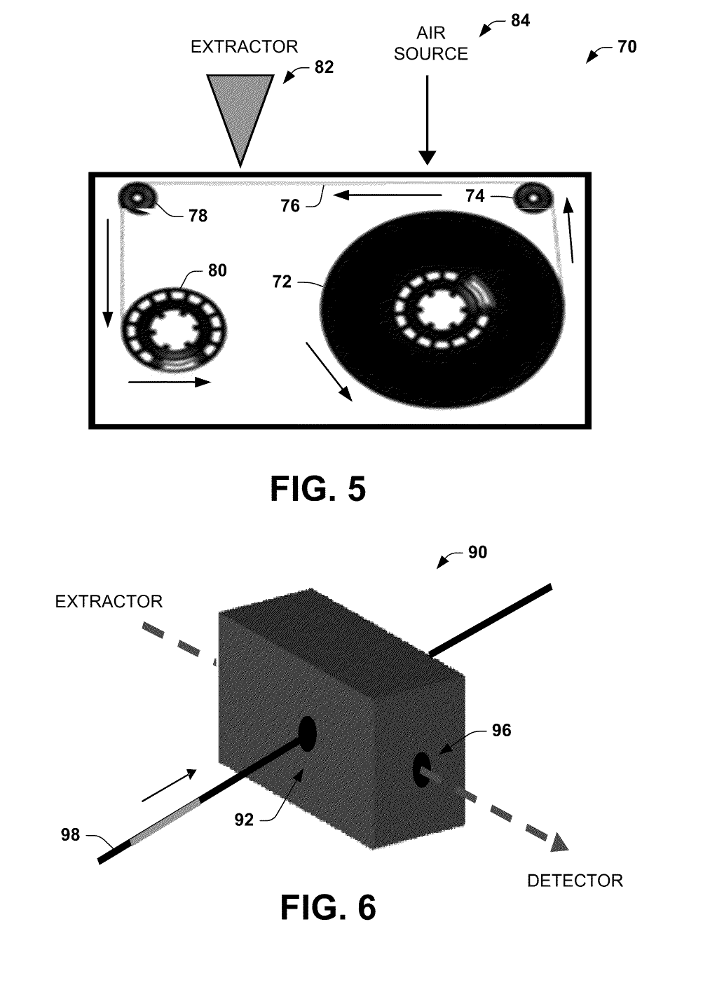

FIG. 5 illustrates another system 70 for collection and analysis of analytes in accordance with another aspect of the present invention. The system 70 includes a roll of low pressure drop sampling material 76 disposed on a first reel 72 that winds around a first roller 74 and second roller 78 to unwind onto a second reel 80. The low pressure drop sampling material 76 can be in the form of a sorbent tape, film, mesh screen or thread. The sampling material 76 passes by an aperture in a wall of the system and is exposed to an air source 84 that contains a given analyte. The analyte is absorbed in a sampling section of the sampling material 76. The sampling can be performed on a discrete sampling section of the sampling material 76 by stopping the reel or the turning on and off of the air supply or on a continuous sampling section of the sampling material 76 by allowing the reel to continue rolling while the air supply remains on. An extractor 82 is positioned downstream of the air sample to extract the analyte from the low pressure drop configuration sampling material. The extractor 64 can be an ambient pressure desorption ionization or laser desorption technique that causes the extraction/desorption of the analyte and providing of the analyte to a detector (not shown).

FIG. 6 illustrates yet another system 90 for collection and analysis of analytes in accordance with another aspect of the present invention. The system 90 includes a thread or fiber of low pressure drop sampling material 98 that includes an sorbed coating of an analyte. The thread or fiber of low pressure drop sampling material 98 is fed through a first end of a first port 92 of the system 90 and exit through a second end of the first port 92. An extractor (not shown) is positioned at an end of a second port 96 that is transverse to the first port 92 of the system 90, such that the sorbed coating of the analyte on the a thread or fiber of low pressure drop sampling material 98 can be exposed to the extractor and the analyte can be extracted and provided out a second end of the second port 96 to a detector (not shown). The extractor can be an ambient pressure desorption ionization or laser desorption technique that causes the extraction/desorption of the analyte and providing of the analyte to the detector.

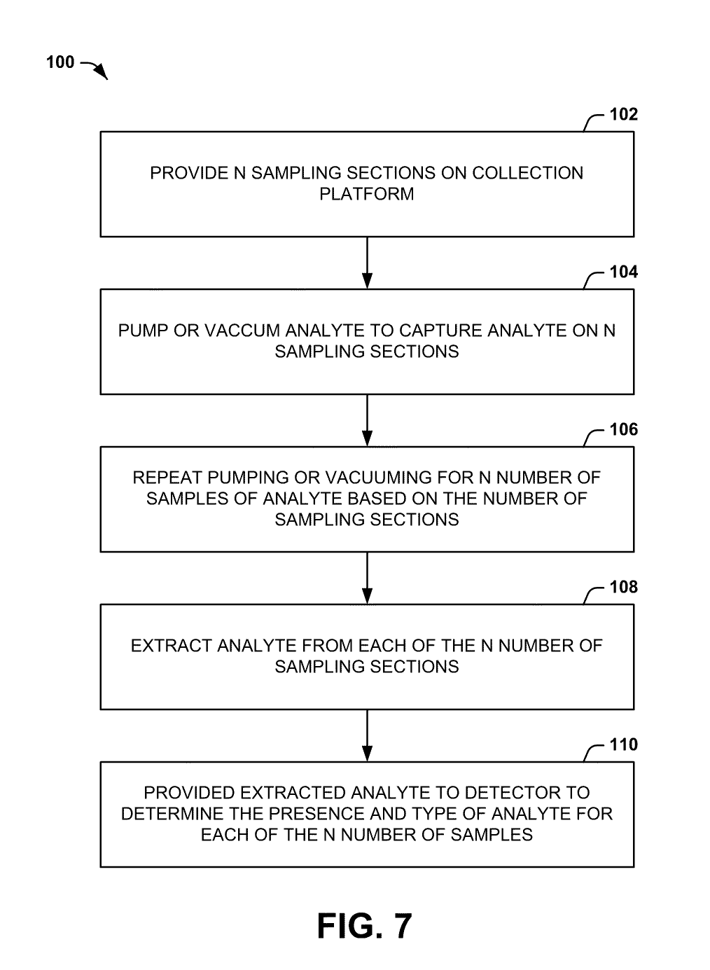

In view of the foregoing structural and functional features described above, a methodology in accordance with various aspects of the present invention will be better appreciated with reference to FIG. 7. While, for purposes of simplicity of explanation, the methodology of FIG. 7 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 7 illustrates an example of a methodology 100 for collecting and analyzing analytes in accordance with an aspect of the invention. At 102, N sampling sections are provided on a collection platform, where N is an integer greater than or equal to one. The collection platform can be but is not limited to a rotatable collection disk or collection tape on a reel or other platforms holding the sampling section(s) with a plurality of discrete sampling sections of sorbent material. At 104, air is provided to pump or vacuum an analyte to capture the analyte on a given sampling section. At 106, the pumping or vacuuming is repeated for N number of samples of analyte based on the N number of sampling sections. At 108, analyte is extracted from each of the N number of sampling sections. At 110, the extracted analyte is provided to one or more detectors to determine the presence and/or type of analyte for each of the N number of samples or to perform a statistical analysis on the N number of samples to determine the presence and/or type of analyte.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A system for collecting analyte comprising:
a sampling section disposed on a collection platform, the sampling section being formed of a low pressure drop configuration of sorbent material; and
an air source that provides an analyte to be sorbed by the sampling section.

2. The system of claim 1, wherein the sorbent material is a material that selectively or non-selectively sorbs vapor phase analytes.

3. The system of claim 1, wherein the collection platform is a fiber or thread.

4. The system of claim 1, wherein the air source blows or vacuums the air containing the analyte to be sorbed by the sampling section.

5. The system of claim 1, wherein the collection platform is a rotatable collection disk, tape or other platform having a plurality of sampling sections disposed about the platform.

6. The system of claim 5, wherein each of the plurality of sampling sections are formed of a low pressure drop configuration of sorbent material.

7. The system of claim 1, further comprising an extractor that extracts the sorbed analyte from the sampling section and provides the extracted sorbed analyte to a detector to determine the presence and/or type of analyte in the sampling section.

8. The system of claim 7, wherein the extractor is at least one of ambient pressure desorption ionization technique, laser desorption technique, thermal or solvent extraction technique, and an ambient pressure desorption ionization technique.

9. The system of claim 8, wherein the ambient pressure desorption ionization source is at least one of a Direct Analysis in Real Time (DART) source and a Desorption ElectroSpray Ionization (DESI) source.

10-20. (canceled)
